(19) United States
(12) Patent Application Publication
(10) Pub. No.: US 2015/0356507 A1
(43) Pub. Date: Dec. 10, 2015

(54) METHOD FOR PROVIDING PRODUCT TOTAL SOLUTION IN WHICH PRODUCT DESIGN, DESIGN COMMUNITY, PRODUCT MANUFACTURING THROUGH DESIGN, AND MARKETING ARE CARRIED OUT ONLINE

(71) Applicant: MOOK CO., LTD., Gyeonggi-do (KR)

(72) Inventors: Ki Bum Park, Seoul (KR); Wo Suk Song, Seoul (KR)

(21) Appl. No.: 14/760,288

(22) PCT Filed: Dec. 9, 2013
(86) PCT No.: PCT/KR2013/011356

§ 371 Date: Jul. 10, 2015

(30) Foreign Application Priority Data
Jan. 11, 2013 (KR) 10-2013-0003301

(51) Int. Cl. G06Q 10/10

(52) U.S. Cl. CPC G06Q 10/101

(57) ABSTRACT

Disclosed is a method for providing a product design online, and more particularly, disclosed is a product total solution providing method in which the product design, sharing and selection of the design, product manufacture through the design, marketing and distribution are made. The online product total solution providing method according to the present invention includes: designing a product by downloading a design application (App.) through a communication network and by performing designing the product through a digital electronic device; ranking the product design by submitting the completed product design to a contest in order that the completed product design is ranked and by scoring and finally ranking the design; sampling the product by causing a management server to request a collaboration manufacturer to sample the product through the communication network when the design is included in a predetermined ranking according to the ranking of the design; requesting the production of the product by causing the management server to request the management server to produce the product for the purpose of the sampling and sale of the product; transmitting profit information by performing the production and sale of the product through on/offline distribution networks and by transmitting the sales of the product or profit corresponding to the sales to the management server through the communication network; and sharing profit by causing the management server to notify a product designer of the profit information through the communication network by using the digital electronic device and by sharing the profit for a predetermined period of time.

### BACKGROUND

1. Field

The present invention relates to a method for providing a product design online, and more particularly to a product total solution providing method in which the product design, sharing and selection of the design, product manufacture through the design, marketing and distribution are made.

2. Description of Related Art

In general, a designer designing a product sketches combinable components on a drawing as a basic work for manufacturing a completed product design.

Areas onto which colors or patterns are mapped should be separated on the sketched drawing. However, the drawing sketch can be made only by a professional designer. For the purpose of completing the final drawing of the product by combining the images of the components on one drawing, it is required to select and re-sketch the image of each component. Therefore, not only non-design professionals but even design professionals have difficulty in designing the product through such a method.

Therefore, recently, the product design is considerably is performed in a digital manner. For example, the combined images are scanned and stored in the form of an image file, or product image files are generated by using graphic tools on a computer.

For example, a clothes design simulation system using an image file and a control method thereof are disclosed in Korean Patent Application Laid-Open No. 2003-00399969.

Describing the clothes design simulation process using the image file disclosed in Korean Patent Application Laid-Open No. 2003-0039969, first, a bitmap image file in which a clothes design has been stored is loaded (S200). Then, the loaded image file reads sequentially color data in accordance with each pixel area of the image data, and distinguishes between a background color and a border color, and then a plurality of image entities constituting the image file are extracted (S210).

The plurality of extracted image entities are hierarchized in the extracted order and are loaded in a memory (S220). The extracted image entities become controllable from an application (App.) module. When the work is requested by a user, the image entities are output on a monitor at the same position in accordance with the position information of an initial image file (S230).

A design worker sets each of the output image entities by items, groups the image entities of the same item, and specifies the attribute of each item. The specified attribute can be tree-structured by the item of each clothes component (S240). The design worker selects and combines the image entities respectively according to needs and designs the completed clothes image (S250).

In Korean Patent Application Laid-Open No. 2003-0039969, a simulation which is almost the same as the design of clothes to be actually produced is provided through an output device in a computer system. Therefore, a cost for producing a prototype can be reduced. However, since the process is complicated, it is not possible to provide a tool capable of allowing common people instead of professional designers to freely design

Also, the system is limited to the design on a website by a professional designer and does not allow common people to utilize. Also, the system has no possibility of being expanded and reproduced to offline marketing.

Also, an accessory design by an accessory design database (DB) through internet websites and an editing system thereof are disclosed in Korean Patent Application Laid-Open No. 10-2009-0000632A.

According to Korean Patent Application Laid-Open No. 10-2009-0000632A, a product design, sharing of the designed product, request for manufacturing the designed product, etc., can be made through websites, so that the problems of the prior art are overcome to a certain degree. However, since the product design, product manufacture, and sharing of the manufactured product are made only by a user, the user must be a professional designer not a common person. As a result, there are still problems of popularization and activation of the above.

### SUMMARY

One embodiment is an online product total solution providing method according to the present invention. The method includes: designing a product by downloading a design application (App.) through a communication network and by performing designing the product through a digital electronic device; ranking the product design by submitting the completed product design to a contest in order that the completed product design is ranked and by scoring and finally ranking the design; sampling the product by causing a management server to request a collaboration manufacturer to sample the product through the communication network when the design is included in a predetermined ranking according to the ranking of the design; requesting the production of the product by causing the management server to request the management server to produce the product for the purpose of the sampling and sale of the product; transmitting profit information by performing the production and sale of the product through on/offline distribution networks and by transmitting the sales of the product or profit corresponding to the sales to the management server through the communication network; and sharing profit by causing the management server to notify a product designer of the profit information through the communication network by using the digital electronic device and by sharing the profit for a predetermined period of time.

In the designing the product, images parted according to parts of the product to be design are provided, and the parted image has connection points of ends thereof, which are connected to other parted images and are defined by specific coordinates. The connection points with the same specific coordinates are connected to each other in accordance with the selection of the parted image, so that a design sketch of the product is completed.

The design sketch which has been completed by the image module has a pattern closed curve area. A color, a skin, or a textile is selected and designed in the pattern closed curve area.

The product is a shoe. The shoe may be provided by being divided into a toe parted image, a side parted image, a counter parted image, and a heel parted image.

The connection points of the ends of the toe parted image are P1, P2, and P3 defined by specific coordinates. The side parted image has the connection portions of one ends thereof, which have the same coordinates as P1, P2, and P3, and has the connection portions of the other ends, have specific coordinates defined by P4, P5, and P6. The counter parted image has the connection portions of one ends thereof, which have the same coordinates as P4, P5, and P6, and has the connection portions of the other ends, have specific coordinates defined by P7, P8, and P9. The heel parted image has the connection portions of the ends thereof, which have the same coordinates as P7, P8, and P9. The coordinates are x-y coordinates in the two-dimensional area and are x-y-z coordinates in the three-dimensional area.

The application provides: a lounge window which is a communication window allowing users to communicate with each other and allowing users to communicate with collaboration manufacturers; a sketch book window which provides a tool which is used to implement the design of an actual product, including the sketch, color, skin, and decoration of the product: and a contest window in which the completed product design is shared and displayed in a contest showroom, and is compared with the designs of other users, and then is scored and ranked in the contest by the users and an administrator.

### BRIEF DESCRIPTION OF DRAWINGS

FIG. 1 is an internal block diagram of an electronic device for implementing a product total solution providing method in which product design, design sharing, product manufacture through the design, and product marketing are made online in accordance with an embodiment of the present invention;

FIG. 2 is a flowchart of the product total solution providing method in which the product design, design sharing, product manufacture through the design, and product marketing are made online in accordance with the embodiment of the present invention;

FIG. 3 shows a product total solution providing screen according to the embodiment of the present invention;

FIG. 4 shows parted images of a shoe in the product design according to the embodiment of the present invention;

FIG. 5 shows a combined image of the shoe through the selection of the parted images of FIG. 4;

FIG. 6 is a view for describing a pattern masking method of a pattern closed curve area assembled by a specific coordinate identification;

FIG. 7 is a view showing that a sketch design of FIG. 4 is colored;

FIG. 8 is a view showing that a skin is designed in the sketch design of FIG. 4;

FIG. 9 is a view showing that decoration is designed in the shoe image;

FIG. 10 is a view showing that the design product is stored and uploaded;

FIGS. 11 to 13 show a screen corresponding to a lounge icon of FIG. 6; and

FIG. 14 is a view showing a configuration of a system for implementing the product total solution providing method according to the embodiment of the present invention.

### DETAILED DESCRIPTION

Hereafter, described will be a product total solution providing method in which product design, sharing design, product manufacture through the design, and marketing are made and the consequent effects thereof.

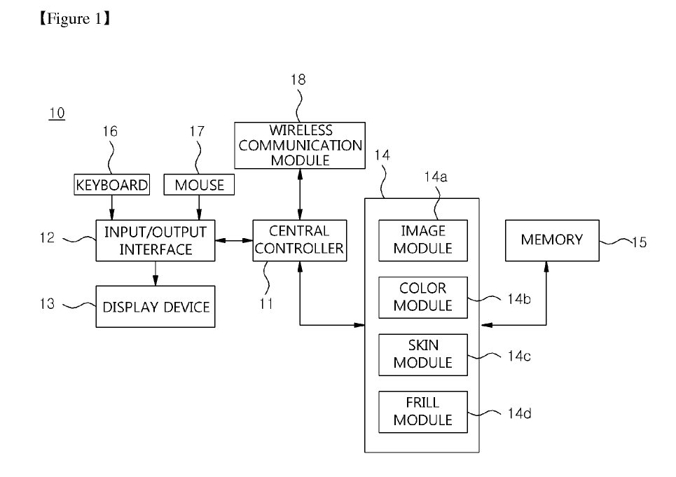

FIG. 1 is an internal block diagram of an electronic device for implementing a product total solution providing method in which product design, design sharing, product manufacture through the design, and product marketing are made online in accordance with an embodiment of the present invention.

Referring to FIG. 1, a digital electronic device 10 which implements the product design by using a specific coordinate image in accordance with the embodiment of the present invention includes a central controller 11, an input/output interface 12, a display device 13, an editing module 14, a memory 15, input units 16 and 17, and a wireless communication module 18.

The central controller 11 is a central processing unit (CPU) and executes and controls an operating system (OS) and various applications.

The input/output interface 12 causes a screen provided by the editing module 14 through control instructions, execution instructions, etc., of the central controller 11 to be displayed on the display device 13 by the execution of the input units 16 and 17.

The display device 13 displays the screen. The display device 13 may be provided in various forms, such as PDP, LCD, OLED, etc.

The editing module 14 provides a screen tool allowing a user to design the product. The screen tool is stored in the memory 15 through a tool providing module.

The editing module 14 may include an image module 14a, a color module 14b, a skin module 14c, a frill module 14d, and a textile module.

The image module 14a provides an image of each part of the product so as to complete the designing of the product to be designed. The partial image is stored in such a manner that the product is divided and the end point of each image is placed in specific coordinates.

When the design of the product is completed as a black and white image through the image module 14a, the color module 14b is a color editing module which creates a variety of color combinations in the resulting image by a closed curve area.

The skin module 14c is directed to a material of the product. The skin module 14c selects and applies a material in conformity with the closed curve area in the product image combined through the image module 14a.

The frill module 14d provides a variety of decorations so as to increase the completeness by adding decoration to the product after the product design is completed through the image module 14a, the color module 14b, and the skin module 14c.

The memory 15 is a storage unit which stores and provides various product design editing tools provided by the tool providing module or stores and provides partial images or images of the material or decoration, etc. The memory 15 may include a read only memory (ROM) including fixed data basically included in a program and an operating parameter which is used by the central controller 11, and a random access memory (RAM) including a program which is executed by the central controller 11 and various parameters which are used during the execution of the program.

The user may operate a keyboard 16 and a mouse 17 in order to input various instructions to the central controller 11. The user may operate the keyboard 16 and the mouse 17 so as to select and indicate areas on the display device 13.

The wireless communication module 18 functions as a communication module which downloads an application (App.) from an app store, etc., and makes the application executable.

The product total solution according to the embodiment of the present invention is provided in the form of an App., and is updated by an application providing server. The product total solution is downloaded and used by an electronic device corresponding to the product total solution.

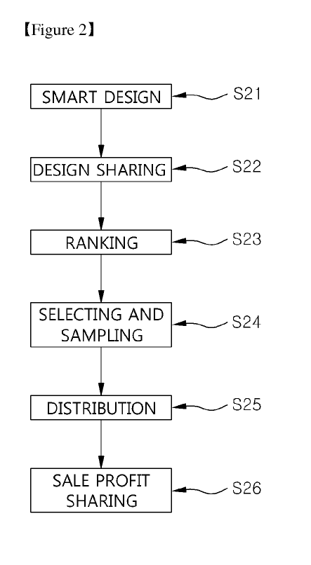

FIG. 2 is a flowchart of the product total solution providing method in which the product design, design sharing, product manufacture through the design, and product marketing are made online in accordance with the embodiment of the present invention.

As shown in FIG. 2, the present invention provides an application (App.) allowing the user (a common person) to design a product (e.g., a shoe), which the user wants, more quickly and better than a designer.

This application (App.) is downloaded from the app store from a digital electronic device through wireless communication and is executed.

The user selects and combines the parted images by a certain rule of the product on the screen on which the application has been executed, and thus, completes a design sketch. Subsequently, the sketched design is variously colored, a skin is selected and various decorations are designed if necessary, so that the design of the product can be completed (S21).

The designed product is stored and uploaded in such a manner as to be shared with other users using the same application (App.) (S22).

The user may not only share the completed design, but also display the corresponding design work in a contest showroom. Also, the user is able to strengthen the professionalism as a product designer through the communication and competition with other users.

The design work which has been displayed in the contest showroom through contests which are hold periodically is scored by an administrator and scores among other users and is ranked in the contest (S23).

Additionally, the design works which have been ranked up to the fifth place (illustratively) are selected as a winning entry. The selected design works are manufactured as actual products (S24).

The sampled and manufactured product is collaborated with manufacturer in the business world and then is commercialized. The sale of the product is made through the corresponding collaboration manufacturers and distribution networks (S25).

The design product is sold with the introduction of the designer for a certain period of time. The royalty for the profit generated during the product selling days or predetermined period of days is paid to the corresponding user (S26).

A series of this business model process will be described in more detail.

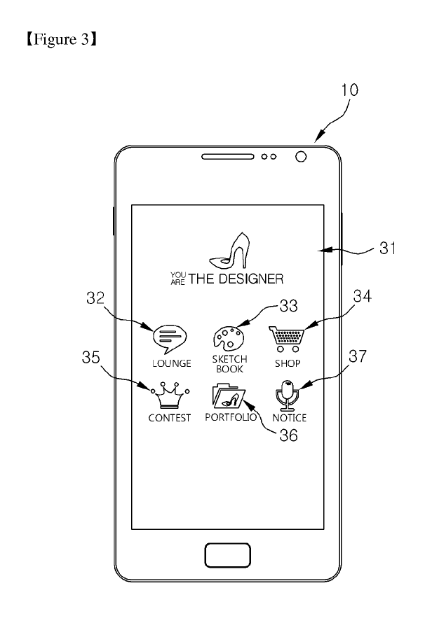

FIG. 3 shows a product total solution providing screen according to the embodiment of the present invention.

As shown in FIG. 3, a product total solution application (App.) of the embodiment of the present invention is downloaded from an app server (app store) and is executed. A screen 31 shown in FIG. 3 will be displayed by executing a corresponding application (App.).

The displayed initial screen 31 includes, for example, six icons. Six icons may represent a lounge 32, a sketch book 33, a shop 34, a contest 35, a portfolio 36, and a public notice 37, respectively.

The lounge 32 is an information sharing place. In the lounge 32, the users share their own design products and trend information on the product. Also, online cafés on common themes and interests among the users are managed in the lounge 32. Also, the lounge 32 functions as a communication window allowing the users to communicate with the collaboration manufacturers.

The sketch book 33 provides a tool which is used to implement the design of the actual product, including the sketch, color, skin, and decoration, etc., of the product.

The contest 35 is a window in which the completed product design is shared and displayed in the contest showroom, and is compared with the designs of other users, and then is scored and ranked in the contest by the users and administrator.

The portfolio 36 corresponds to a personal portfolio folder which allows a user to arrange, upload and store his or her own designed products by items and to modify the product design anytime and to enter a design contest.

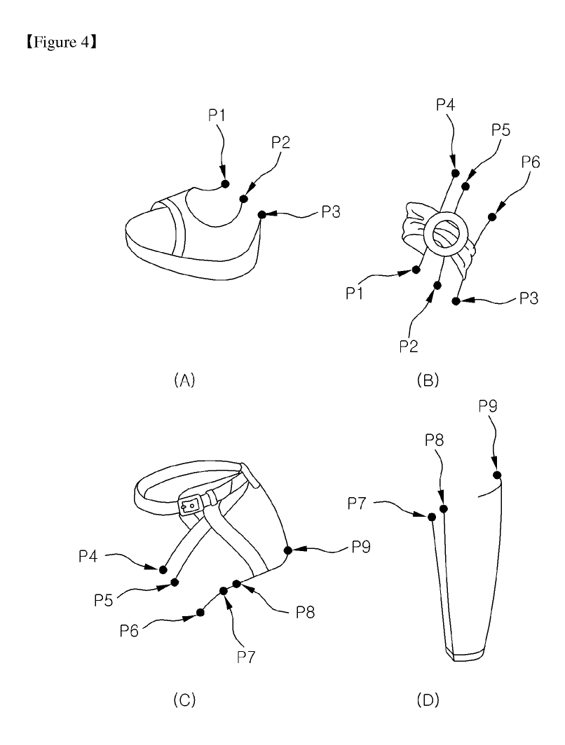

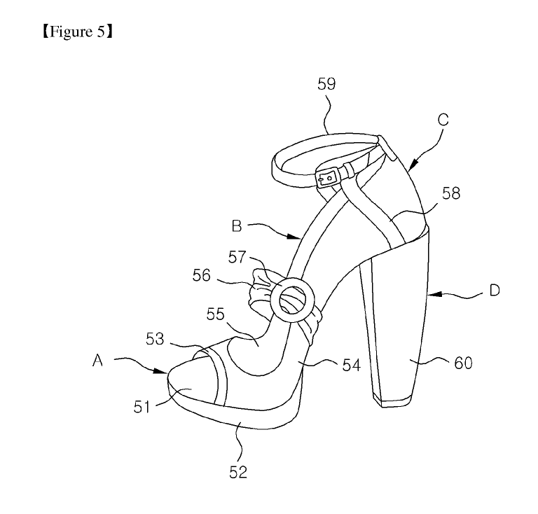

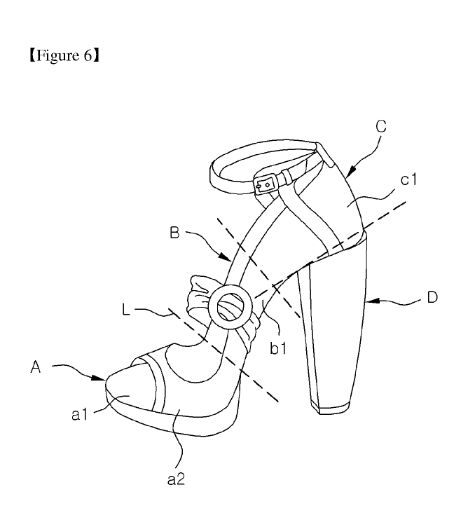

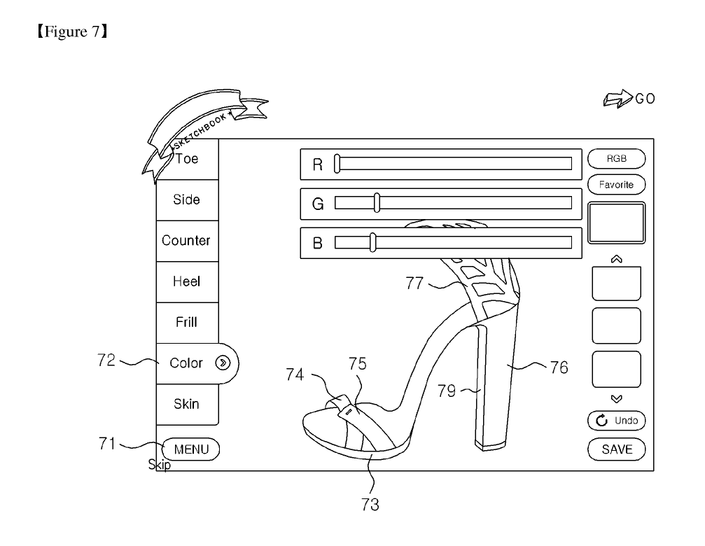

FIG. 4 shows parted images of a shoe in the product design according to the embodiment of the present invention. FIG. 5 shows a combined image of the shoe through the selection of the parted images of FIG. 4. FIG. 6 is a view for describing a pattern masking method of a pattern closed curve area assembled by a specific coordinate identification. FIGS. 7 to 9 are views showing that a sketch design of FIG. 4 is colored and a skin and decoration are designed in the sketch design of FIG. 4.

The description of the parted images shown in FIG. 4 will focus on a shoe. Other products (e.g., bags, accessories, running shoes, clothes, etc.) are based on the same principle.

Basically, the parted image is distinguished by each part of the entire product. The end point (i.e., a connection point connected to other parted images) of the parted image distinguished by each part is recognized and stored as a specific coordinate point.

FIG. 5 shows that a full image of the product has been designed through a combination of the parted images shown in FIG. 4.

The digital electronic device 10 which implements the product design by using a specific coordinate image provides a variety of basic designs for the product design. For example, various parted images are provided on the basis of an image of a women's shoe with a heel shown in FIG. 5.

Based on the shoe's image shown in FIG. 5, the embodiment of the present invention provides four parted images (A to D of FIG. 4). The user is allowed to select and use the parted images.

The shoe shown in FIG. 5 is, as shown in FIG. 4, provided by being divided into a toe parted image A, a side parted image B, a counter parted image C, and a heel parted image D.

The toe parted image A corresponds to a toe portion of the shoe. The toe portion is freely parted, and connection points (P1, P2, and P3) of ends thereof are defined by specific coordinates (can be defined by x-y coordinates in the two-dimensional area or by x-y-z coordinates in the three-dimensional area).

The side parted image B corresponds to a side portion of the shoe, which is connected to the toe portion of the shoe. Similarly, the side portion is freely parted, and the connection portions of one ends thereof, which are connected to the connection points (P1, P2, and P3) of the toe parted image A are specified by the same coordinates, that is to say, by the coordinates of (P1, P2, and P3). Also, the connection points (P4, P5, and P6) of the other ends are specified by another coordinates.

The counter parted image C corresponds to a rear portion of the shoe, which is connected to the side portion of the shoe. Similarly, the connection points (P4, P5, and P6) of forward ends are connected to the connection points (P4, P5, and P6) of the side parted image B and are defined by the same specific coordinates. Any lower connection points (P7, P8, and P9) are defined by another specific coordinates.

The heel parted image D corresponds to a heel which is connected to the counter of the shoe. The connection points (P7, P8, and P9) of the ends which is connected to the counter parted image C are connected to the lower connection points (P7, P8, and P9) and are defined by the same specific coordinates.

In the parted images, the connection points with the same specific coordinates are connected to each other, so that one completed product image is obtained. By the combination of the selected parted images shown in FIG. 4, the design of the shoe shown in FIG. 5 is obtained. This corresponds to a sketch of the shoe design.

The parted images provided in FIG. 4 are selected by the user among the parted images which are stored in the memory 15 and are displayed on the display device 13 by the input/output interface 12 under the control of central controller 11. The parted images provide various images according to each part. The parted images according to each part are defined by the same specific coordinates.

That is, in a toe parted image providing tool, a plurality of toe parted images are provided on the screen and are freely selected by the user. The connection points of the plurality of toe parted images are all defined by the same specific coordinates. In other words, as shown in FIG. 4, the connection points are defined by the same specific coordinates of (P1, P2, and P3), and the same is true for the side parted image, counter parted image and heel parted image.

By the selection of the parted images shown in FIG. 4, the sketch design of the shoe is completed as shown in FIG. 5. The sketch design has a plurality of pattern closed curves indicated by the reference numerals of 51 to 60. The pattern closed curves 51 to 60 provide areas where textile internal process designs of the color and skin are completed.

Here, the pattern closed curve is defined as follows.

Referring to FIG. 6, the design sketch is completed by assembling the parted images shown in FIG. 4 in accordance with the design method of the present invention.

The pattern closed curve areas are indicated in the completed design sketch (reference numerals of 51 to 60 in FIG. 5).

A straight line L shown in FIG. 6 corresponds to a line extending the connection points of each parted image. Each parted image is represented by A, B, C, and D.

The parted images A to D are selected and the connection points thereof are connected to each other, so that the design sketch is completed and a variety of pattern closed curves are formed according to the completed design sketch.

“a1” among the pattern closed curves represents an inner material of the toe parted image A, and “a2” represents an outer material of the toe parted image A. “b1” represents an outer material of the side parted image B, and “c1” represents an outer material of the counter parted image C.

Here, since “a1” represent the inner material and “a2”, “b1”, and “c1” represent the outer material and form the side of the shoe, the color and material should be the same.

Therefore, in this case, for the purpose of the design implementation of the present invention, a masking area by each part is defined as follows.

a1: Hel_Toe_Lv04_M001_{—}201

a2: Hel_Toe_Lv04_M001_{—}202

b1: Hel_Sde_Lv04_M002_{—}202

c1: Hel_Cnt_Lv03_M001_{—}150

That is to say, the masking area by each part may be defined by A_P_L_M_D.

Here, “A” represents categories of a women's shoe and is divided into Heels, Flats, Mules & Clogs, Platforms or Pumps, etc. Hel represents heels.

“P” represents a parted portion and is herein divided into Toe, Side, Counter and Heel. “Toe” represents Toe as it is. “Sde” represents Side. “Cnt” represents Counter.

“L” represents a level value of a line of each pattern closed curve. “M” represents a value which distinguishes which area is which (or type number of Toe) in the parted image of two rows.

“D” is a masking number and represents a color value. The masking number is set in the skin and decoration according to the kind thereof.

Regarding the above defined masking area “a1”, the category of the shoe is a heel, the parted portion is a toe, the level value of the closed curve is Lv04, the type of toe is M001, and the color value is 201.

Regarding the masking area “a2”, the category of the shoe is a heel, the parted portion is a toe, the level value of the closed curve is Lv04, the type of toe is M001, and the color value is 202.

Regarding the masking area “b1”, the category of the shoe is a heel, the parted portion is a side, the level value of the closed curve is Lv04, the type of toe is M002, and the color value is 202.

Regarding the masking area “c1”, the category of the shoe is a heel, the parted portion is a counter, the level value of the closed curve is Lv03, the type of toe is M001, and the color value is 150.

Here, the parted portions of “a2” and “b1” are different, however, the closed curves are the same as each other, so that “a2” and “b1” have the same color value. “a1” and “a2” have the same parted portion, however, have different materials (inner material and outer material), so that “a1” and “a2” have different color value. Likewise, since “c1” has a different parted portion and a different material from those of others, the color value of the “c1” is defined differently. As with the color, the skin is defined in the same manner.

As described above, the design implementing electronic device according to the embodiment of the present invention parts certain portions of the product design consisting of specific coordinates and variously combines the parts. The parts are simply loaded through digital devices, computers, smartphones, tablet PCs, or the like and are designed according to the number of cases, and various colors/textiles/skins are used in the pattern closed curves created by the completion of the design sketch, and thus, “smart design” can be completed. Therefore, not only professional designers but even a common person is able to easily design the product.

By use of this pattern closed curves, the product design can be colored, and skin and decoration are designed in the product design through the screens of FIGS. 7 to 9.

Referring to FIG. 7, after completing s the design sketch of FIG. 5, the user colors in accordance with each area.

The screen shown is provided when a color icon 72 is selected through a menu icon 71. The screen provides 256 colors of RGB combination.

The user may select any one of the pattern closed curves 51 to 60 of FIG. 5 and may apply and store the color.

A tool is provided which causes the areas of the pattern closed curves 51 to 60 to be selected by selecting and combining any points within the closed curve or at least one spline forming the closed curve.

FIG. 7 shows the areas of various pattern closed curves 73 to 77 and shows a result obtained by selecting and applying a shocking pink color to the areas of the pattern closed curves indicated by the reference numerals 73, 74, 76, and 77 and by selecting and applying an orange color to the areas of the pattern closed curves indicated by the reference numerals 75 and 77.

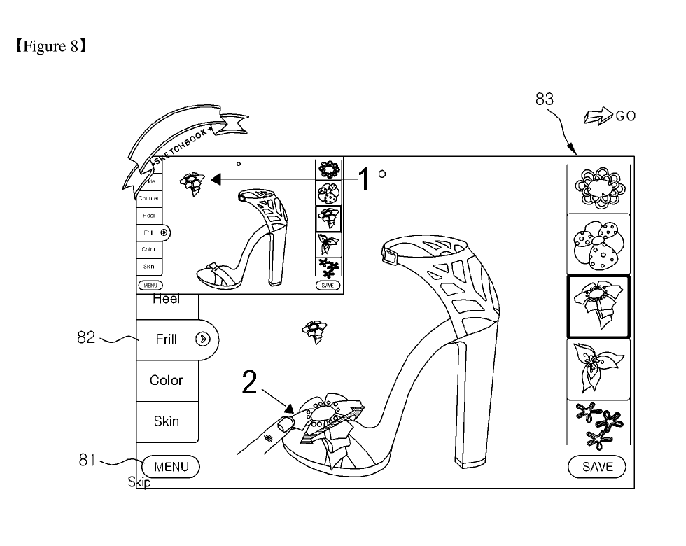

Referring to FIG. 8, FIG. 8 shows a tool screen for various shoe decoration design after the process shown in FIG. 7.

When a menu icon 81 is selected and then a Frill icon 82 is selected, a Frill screen 83 representing various shapes of decorations is displayed on the right side. When one of the decorations is selected, the selected decoration is displayed on any position of the screen.

The user places the selected decoration on his/her favorite position, and then is able to controls the size of the decoration by expanding the screen and to delete the decoration.

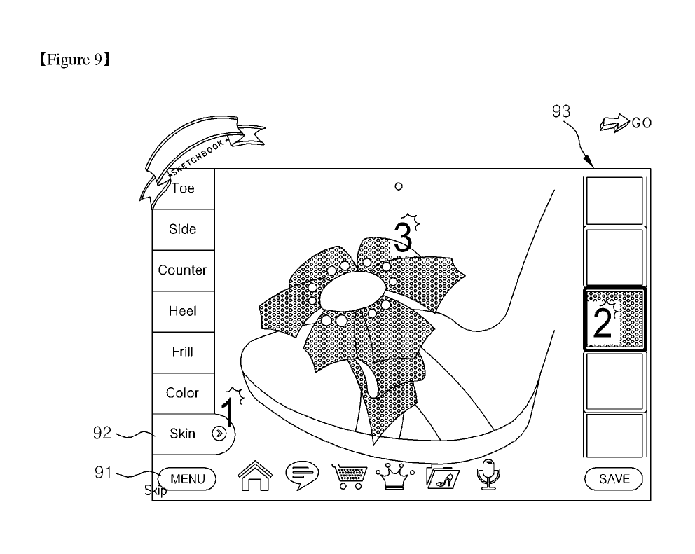

Referring to FIG. 9, after the sketch of the shoe, color combination and decoration are completed, each part of the shoe and decoration materials are selected and applied.

When a menu icon 91 is selected and then a Skin icon 92 is selected or when the Skin icon 92 is directly selected, a skin screen 93 representing various types of skins is displayed on the right side.

When a favorite skin is selected on the skin screen 93 and a pattern closed curve (which means a closed surface area) to which the selected skin is applied is selected, the skin is applied.

Regarding the product design using the specific coordinate image according to the embodiment of the present invention, certain portions of the product design consisting of specific coordinates are parted and the parts are variously combined. The parts are simply loaded through electronic devices (digital devices, computers, smartphones, tablet PCs, or the like) and are designed according to the number of cases, and various colors/textiles/skins are used in the pattern closed curves created by the completion of the design sketch, and thus, “smart design” can be completed.

According to the product design implementing method of the embodiment of the present invention, the product design is completed by assigning specific coordinates to the parted image, by providing the design sketch completed by connection of the same specific coordinates, by creating certain pattern closed curves on the completed design sketch by combining the parted images, and by combination of color insertion, skin selection or decoration selection within the area of the pattern closed curve.

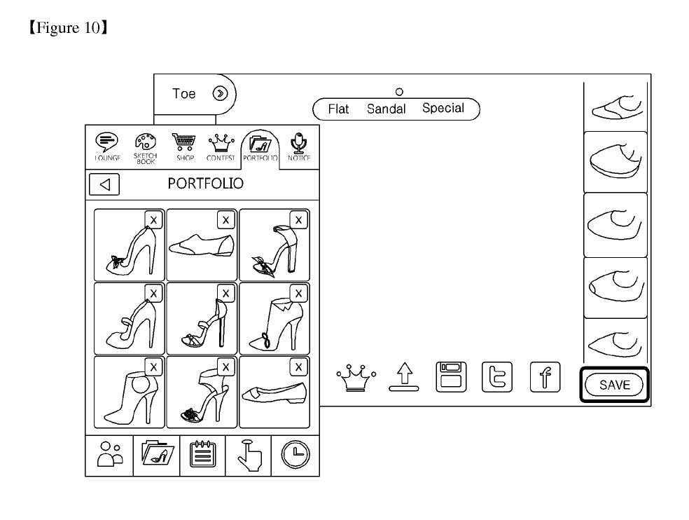

FIG. 10 is a view showing that the design product is stored and uploaded.

After the product design is completed through FIGS. 4 to 9, as shown in FIG. 10, a user's own design can be loaded in the lounge 32 through a SAVE button, be directly submitted to the contest 35 and be stored in my portfolio 36.

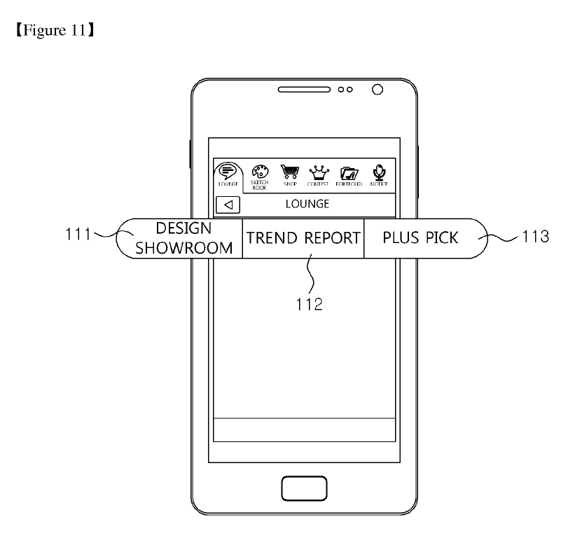

FIGS. 11 to 13 show a screen corresponding to the lounge icon of FIG. 6.

An icon corresponding to the lounge 32 may provide a design showroom 111, a trend report 112, and a plus pick 113 icon.

FIG. 11 shows a window at the time of selecting the design showroom 111. The design showroom 111 is an information exchange window allowing the users to share their creative product designs.

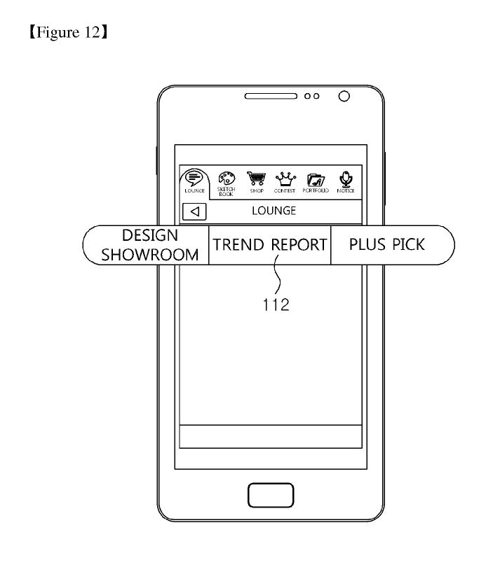

FIG. 12 is a screen at the time of selecting the trend report 112. The trend report 112 is a window allowing the users to upload and exchange any information which captivates the users, for example, a recent popular trend, hot items in an international collection, and the like.

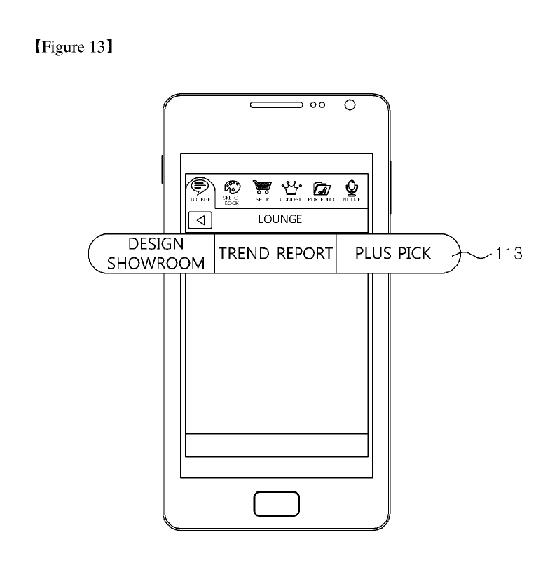

FIG. 13 is a screen at the time of selecting the plus pick 113 icon. The plus pick 113 icon is a window allowing the users to add stylish friends made in the lounge and trend report to the plus pick, and then to see the activities of the friends, such as an item sharing, etc.

The design product of the user uploaded in the contest 35 is scored and ranked by other users and administrator.

The design included within a certain ranking is sampled. The sampled product is produced by the collaboration manufacturer and is actually commercialized, and then is sold through the collaboration manufacturers and distribution networks.

Regarding the profit generated by the sold products, a royalty for a certain profit is paid to product designers in accordance with a predetermined standard (period, share rate, others, etc.).

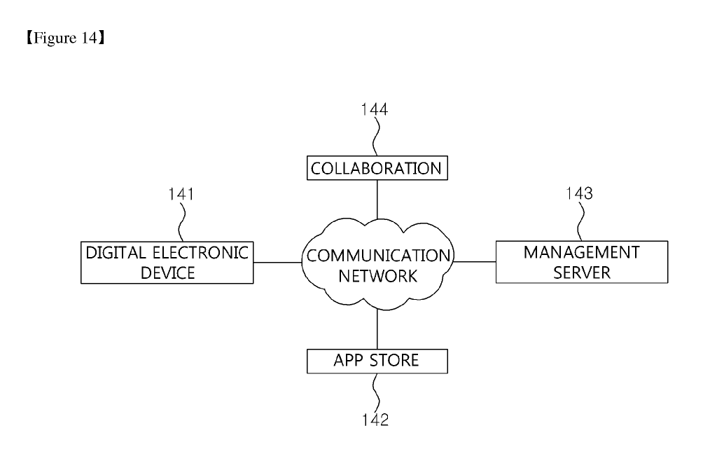

FIG. 14 is a view showing a configuration of a system for implementing the product total solution providing method according to the embodiment of the present invention.

When the design of the product is completed through FIGS. 4 to 9 and is included within a certain ranking through the contest, the manufacture of the product by sampling, the sale of the product, and sale profit process are performed.

Describing a series of this process by referencing FIG. 14, first, the user downloads an application (App.) from an app store 142 through a communication network by using his/her own digital electronic device 141.

The app store 142 may include a server which is configured such that developers develop programs and register the programs in a web and a plurality of smartphone users requiring the registered programs access the web and download the programs at a certain cost or for free. The app store 142 is referred to as an online mobile content open market which sells a variety of applications (Apps.) which can be installed on the smartphone.

A management server 143 corresponds to a developer of the application (App.) or administrator.

The user completes the design of the product through an application (App.) corresponding thereto, uploads the completed design in the contest, and is included within a certain ranking through a certain process. Then, the management server 143 causes a collaboration manufacturer 144 to produce the product.

The collaboration manufacturer 144 produces the product and sells using an online or offline distribution network. The sales or profit of the sold product are transmitted to the management server 143 through the communication network. The management server 143 notifies a designer corresponding to the product of the sales or profit in real time or periodically or on a predetermined expiration date, etc., and causes the royalty for the sales profit to be paid.

Unlike a general consumer marketing where a common person provides ideas, the aforementioned present invention provides a new business model allowing staffs of the manufacturer, designer, and marketers to cause the products designed through the smart design to be included in a distribution cycle.

While the embodiment of the present invention has been described with reference to the accompanying drawings, it can be understood by those skilled in the art that the present invention can be embodied in other specific forms without departing from its spirit or essential characteristics. Therefore, the foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A product total solution providing method in which product design, design sharing, product manufacture through the design, and product marketing are made online, the method comprising:
designing a product by downloading a design application (App.) through a communication network and by performing designing the product through a digital electronic device;
ranking the product design by submitting the completed product design to a contest in order that the completed product design is ranked and by scoring and finally ranking the design;
sampling the product by causing a management server to request a collaboration manufacturer to sample the product through the communication network when the design is included in a predetermined ranking according to the ranking of the design; and
requesting the production of the product by causing the management server to request the management server to produce the product for the purpose of the sampling and sale of the product.

2. The product total solution providing method of claim 1, wherein, after the requesting the production of the product, further comprising:
transmitting profit information by performing the production and sale of the product through on/offline distribution networks and by transmitting the sales of the product or profit corresponding to the sales to the management server through the communication network; and
sharing profit by causing the management server to notify a product designer of the profit information through the communication network by using the digital electronic device and by sharing the profit for a predetermined period of time.

3. The product total solution providing method of claim 1,
wherein, in the designing the product, images parted according to parts of the product to be design are provided, and the parted image has connection points of ends thereof, which are connected to other parted images and are defined by specific coordinates,
and wherein the connection points with the same specific coordinates are connected to each other in accordance with the selection of the parted image, so that a design sketch of the product is completed.

4. The product total solution providing method of claim 3,
wherein the design sketch which has been completed by the image module has a pattern closed curve area,
and wherein a color, a skin, or a textile is selected and designed in the pattern closed curve area.

5. The product total solution providing method of claim 3,
wherein the product is a shoe,
and wherein the shoe is provided by being divided into a toe parted image, a side parted image, a counter parted image, and a heel parted image.

6. The product total solution providing method of claim 5,
wherein the connection points of the ends of the toe parted image are P1, P2, and P3 defined by specific coordinates,
wherein the side parted image has the connection portions of one ends thereof, which have the same coordinates as P1, P2, and P3, and has the connection portions of the other ends, have specific coordinates defined by P4, P5, and P6,
wherein the counter parted image has the connection portions of one ends thereof, which have the same coordinates as P4, P5, and P6, and has the connection portions of the other ends, have specific coordinates defined by P7, P8, and P9,
wherein the heel parted image has the connection portions of the ends thereof, which have the same coordinates as P7, P8, and P9,
and wherein the coordinates are x-y coordinates in the two-dimensional area and are x-y-z coordinates in the three-dimensional area.

7. The product total solution providing method of claim 1, wherein the application provides:
a lounge window which is a communication window allowing users to communicate with each other and allowing users to communicate with collaboration manufacturers;
a sketch book window which provides a tool which is used to implement the design of an actual product, including the sketch, color, skin, and decoration of the product; and
a contest window in which the completed product design is shared and displayed in a contest showroom, and is compared with the designs of other users, and then is scored and ranked in the contest by the users and an administrator.
